(19) United States
(12) Patent Application Publication
(10) Pub. No.: US 2006/0176382 A1
(43) Pub. Date: Aug. 10, 2006

(54) Image sensor for reducing vertically-striped noise

(75) Inventors: Asao Kokubo, Kawasaki (JP); Hiroshi Daiku, Kawasaki (JP); Jun Funakoshi, Kawasaki (JP); Hiroshi Kobayashi, Kawasaki (JP); Wakako Hoshino, Kawasaki (JP)

Correspondence Address: ARENT FOX PLLC, 1050 CONNECTICUT AVENUE, N.W., SUITE 400, WASHINGTON, DC, 20036, US

(73) Assignee: FUJITSU LIMITED

(21) Appl. No.: 11/143,665

(22) Filed: Jun. 3, 2005

(30) Foreign Application Priority Data
Feb. 4, 2005 (JP) 2005-028443

(51) Int. Cl. H04N 5/335

(52) U.S. Cl. 348/294

(57) ABSTRACT

In an image sensor provided with an AD conversion circuit in each column, the offset value of each AD conversion circuit disposed in each column is corrected, using a value based on the output in each column of a plurality of lines composed of shielded pixels in order to provide an effective method for reducing vertically-striped noise due to the variation of the offset element of the AD conversion circuit.

### CROSS-REFERENCE TO RELATED APPLICATIONS

This application is based upon and claims the benefit of priority from the prior Japanese Patent Application No. 2005-028443 filed on Feb. 4, 2005, the entire contents of which are incorporated herein by reference

### BACKGROUND OF THE INVENTION

1. Field of the Invention

The present invention relates to the noise reduction processing method of an image sensor, and more particularly, relates to a method for reducing vertically-striped noise due to the variation of the offset element of an AD conversion circuit (ADC) disposed in each column.

2. Description of the Related Art

Each AD circuit disposed in each column shows variation of a characteristic, and its offset value differs. For this reason, the offset value is corrected by subtracting the value of a shielded pixel (reference black level) with a similar offset from a valid pixel in each column.

Such prior art is described below with reference to FIGS. 1 through 5.

FIG. 1 shows an example of the configuration of an image sensor in which an AD conversion circuit 7 is disposed in each column.

The image sensor 1 comprises a valid pixel array 2, a plurality of lines of shielded pixels 3 and 4, a row selector 5 for selecting a pixel line, that is, row, a column selector 6 for selecting a column, an AD conversion circuit 7 disposed in each column, a noise reduction circuit 8 for reducing the noise of pixel data which is the output of the AD conversion circuit 7 and a timing generator 9 for supplying the row selector 5 and column selector 6 with row and column selection timing pulses, respectively, and supplying the noise reduction circuit 8 with control signals B0, HD and VD.

FIG. 2 shows the conventional timing of a pixel outputted to the output ADOUT of the AD conversion circuit. FIG. 2 shows the relationship among the control signals, row and column count values and the pixel data outputted to the output ADOUT of the AD conversion circuit, the switching of a line to be read at the timing of the rising edge of the signal HD and the reading of a valid pixel at the timing of the rising edge of the signal VD. The pixels of a line indicated by a row count while signal HD is high are read in the order of a column count. The data outputted while signal HD is low, that is, a line switching period, is invalid.

FIG. 3 shows the conventional leading read position of a row counter and shielded line used for offset compensation. In FIG. 3, there are four shielded pixel lines above and below valid pixels, which shows that the top line of the upper shielded lines is read at first and that an offset value is corrected using the output of the pixels of line 0.

FIGS. 4 and 5 show the configuration and operation, respectively, of a conventional offset correction circuit in the noise reduction circuit 8.

Since as shown in FIG. 5, control signal B0 is high only when shielded line 0 is specified, the pixel of shielded line 0 is AD-converted and is written into the RAM 91 shown in FIG. 4. When signal VD rises and becomes high, and a valid pixel Pxₙ is read, the value B0ₙ of the pixel of the shielded line 0 is also read from the RAM 91. Then, the value B0ₙ is subtracted from the value of the valid pixel by a subtracter 92, and the subtraction result is inputted to a limiter circuit 93. Then, its range of possible values is restricted and the result is outputted to POUT. In the example shown in FIG. 4, the upper limit of a pixel value is limited to “511”, and its negative value is made “0”.

However, if an offset value is corrected only by shielded line 1 as in the conventional method, as shown in FIG. 10B, the offset cannot be corrected sufficiently, and as a result, vertically-striped noise appears on the screen.

As causes of the occurrence of vertically-striped noise due to insufficient correction, the position and characteristic variations of valid/shielded pixels, the influence of power supply noise and the like can be considered besides the AD conversion circuit.

If there is a pixel defect in one shielded line as well, an offset value is erroneously corrected, which is another problem.

Next, the prior art in the technical field related to the present invention is introduced.

Japanese Patent Application No. 2003-304455 discloses compensating for the black level of a pixel in an image sensor by averaging of the entire shielded pixel area and performing the compensation of the black level prior to AD conversion. However, the vertically-striped noise due to the characteristic variation of the AD conversion circuit disposed in each column is not addressed.

Japanese Patent Application No. 2002-269549 discloses adjusting the offset value of the AD conversion circuit on an image reader device. However, this is performed to correct variation in each divided image area in order to improve its reading speed, using the average of all pixels in the divided image area.

As described above, there was no effective method for reducing vertically-striped noise due to the variation of the offset element of the AD conversion circuit disposed in each column of an image sensor.

### SUMMARY OF THE INVENTION

It is an object of the present invention to provide an effective method for reducing vertically-striped noise due to the variation of the offset element of an AD conversion circuit in an image sensor provided with an AD conversion circuit in each column.

The offset value of each AD conversion circuit disposed in each column is corrected using a value based on the output in each column of a plurality of lines composed of shielded pixels.

The vertically-striped noise can be reduced by averaging the variation of an offset or a shielded pixel according to the present invention, compared to the conventional method.

### BRIEF DESCRIPTION OF THE DRAWINGS

FIG. 1 shows an example of the configuration of a conventional image sensor.

FIG. 2 shows the conventional timing of a pixel outputted to ADOUT of the AD conversion circuit.

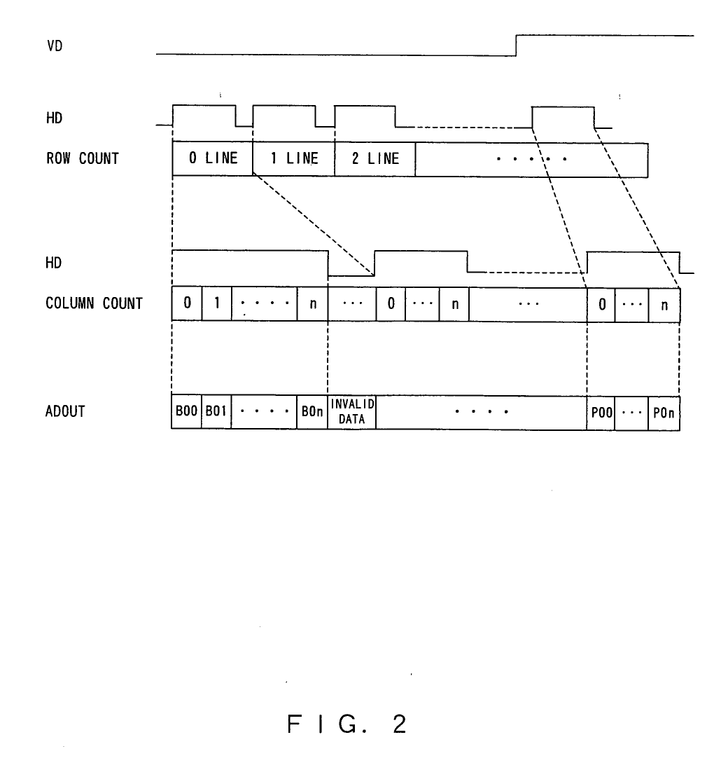

FIG. 3 shows the conventional leading row read position and a shielded line used to correct an offset value.

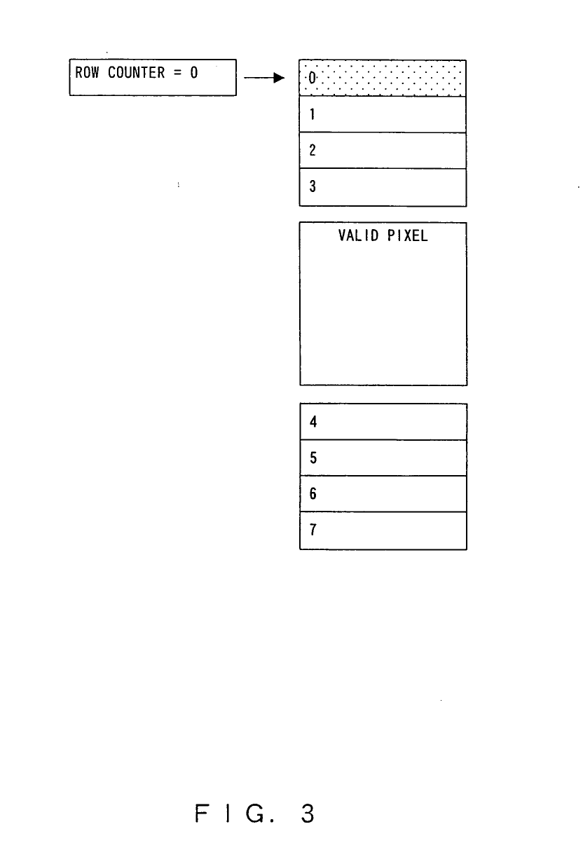

FIG. 4 shows the configuration, operation and output of the conventional offset correction circuit.

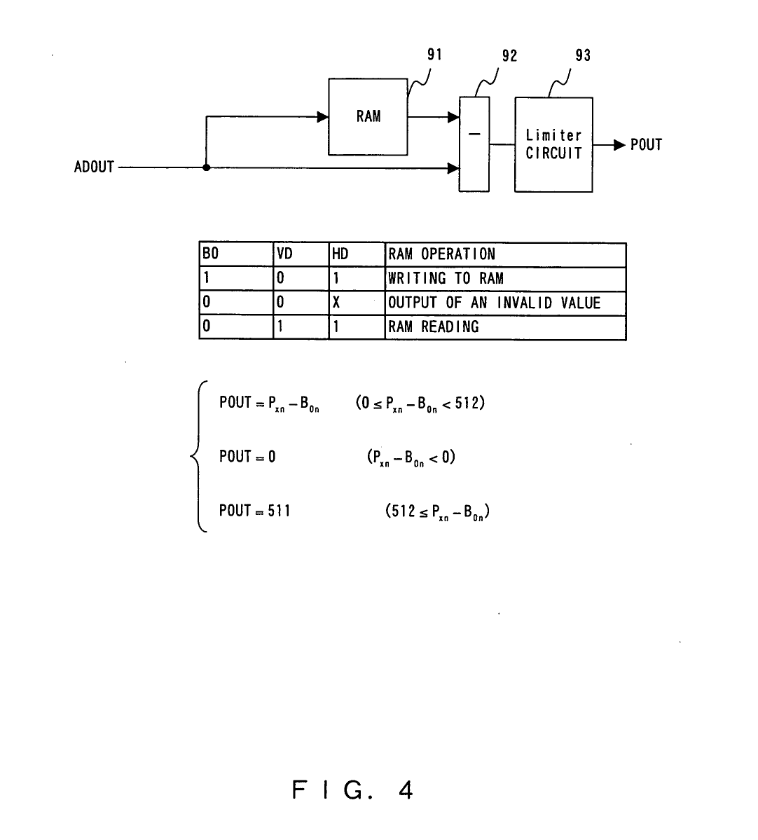

FIG. 5 shows the conventional pixel reading operation timing.

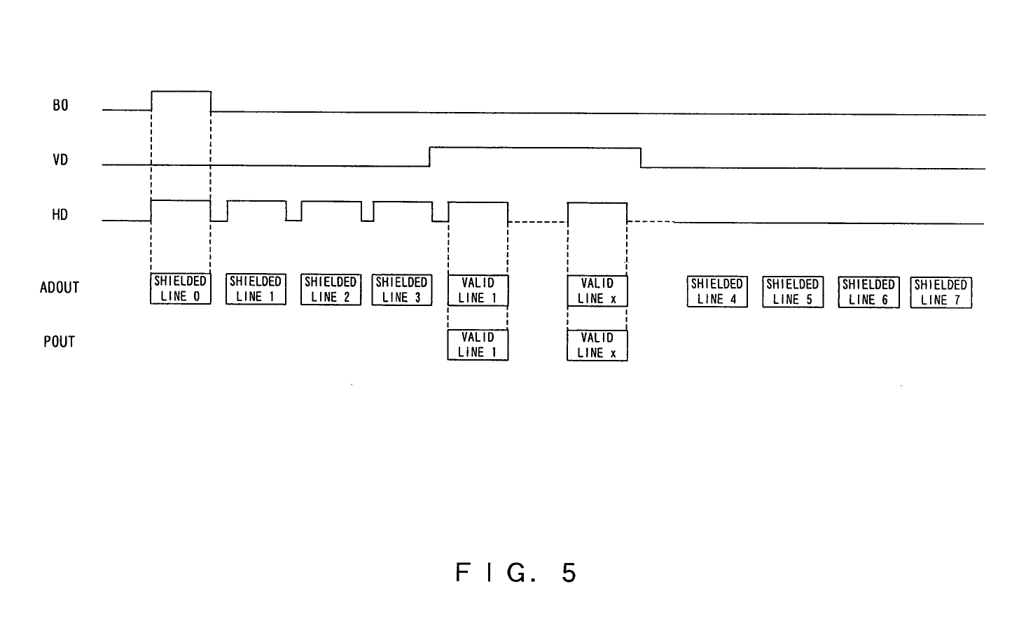

FIG. 6 shows the configuration of the image sensor of the present invention.

FIG. 7 shows the configuration, operation and output of the offset correction circuit of the present invention.

FIG. 8A shows the leading row read position and a shielded line used to correct an offset value in the first preferred embodiment of the present invention.

FIG. 8B shows the pixel reading operation timing in the first preferred embodiment of the present invention.

FIG. 9A shows the leading row read position and a shielded line used to correct an offset value in the second preferred embodiment of the present invention.

FIG. 9B shows the pixel reading operation timing in the second preferred embodiment of the present invention.

FIG. 10A shows the result in the case where an offset value is ideally corrected.

FIG. 10B shows the conventional correction result of an offset value.

FIG. 10C shows the correction result of an offset value of the present invention.

### DESCRIPTION OF THE PREFERRED EMBODIMENTS

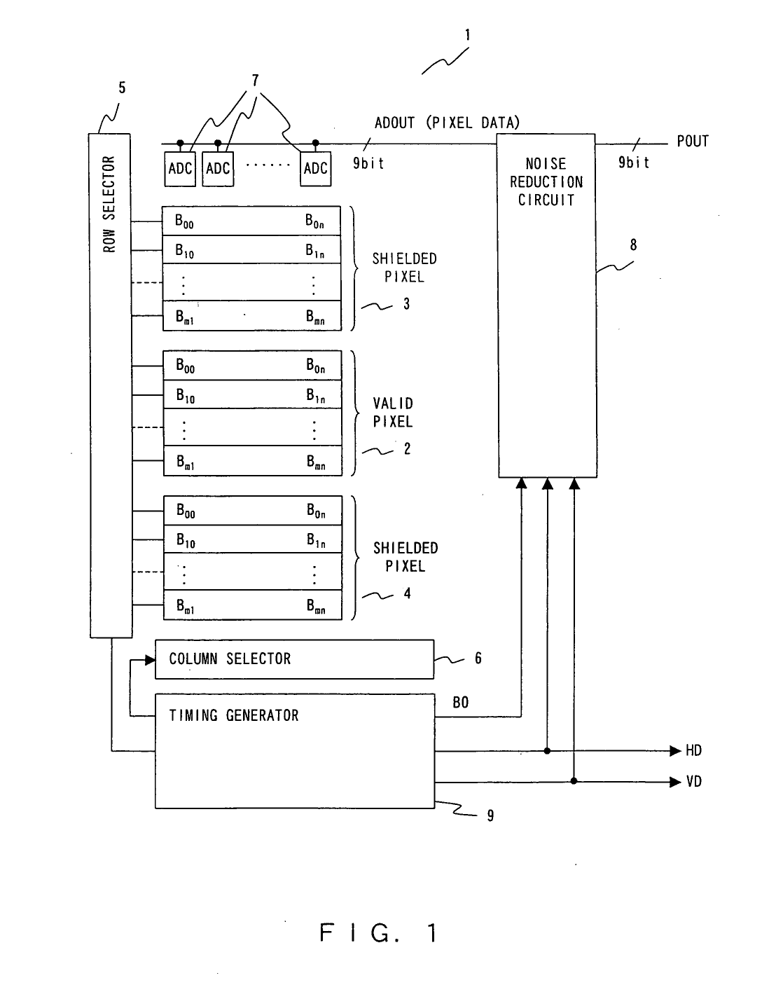

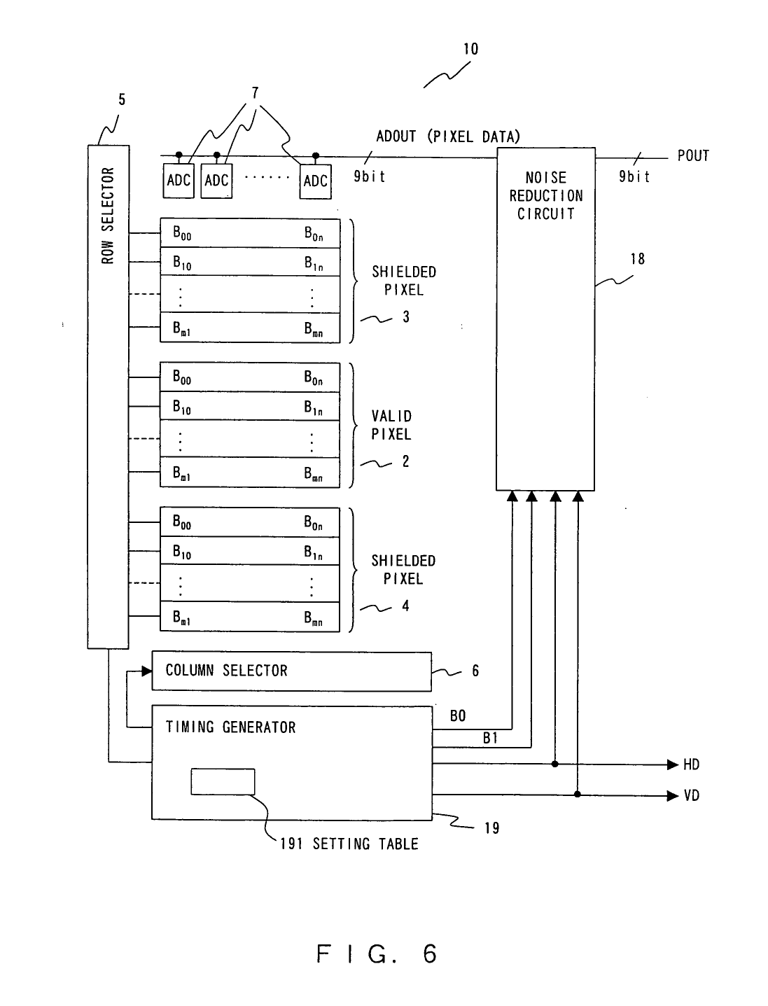

FIG. 6 shows the configuration of the image sensor 10 of the present invention. The configuration shown in FIG. 6 differs from that shown in FIG. 1 in that a timing generator 19 comprises a setting table 191 and a shielded line used to correct the offset value of an AD conversion circuit can be specified and modified by specifying its setting value externally and that a control signal B1 is further supplied in addition to the control signal supplied by the timing generator 9 shown in FIG. 1. Furthermore, the internal configuration of the noise reduction circuit 18 for receiving the control signal B1 differs from that of FIG. 1.

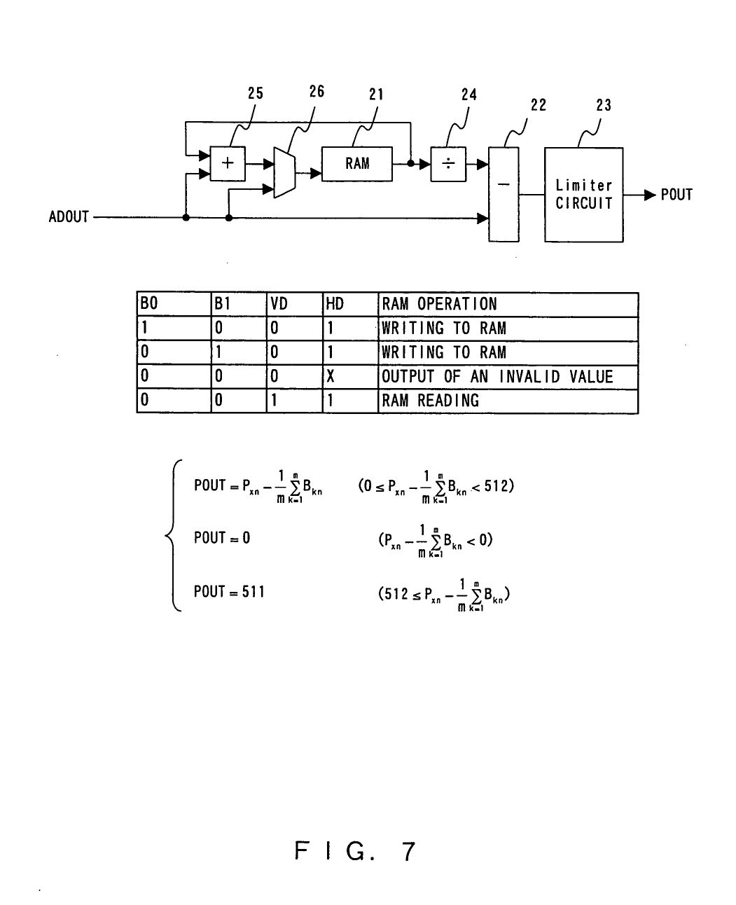

FIG. 7 shows the configuration, operation and output of the offset correction circuit in the noise reduction circuit 18. When B0 is “1”, a selector 26 selects the data of ADOUT, which is the output of the AD conversion circuit, and writes the data into a RAM 21. While B1 is “1”, the data of ADOUT, which is the output of a shielded line, is one input of two to adder 25. To the other input of the adder 25, the data of the pixel of a shielded line accumulated and added in the RAM 21 is input. If the number of lines used to correct an offset value is m, (m-1) times of additions are performed. The addition result is stored in the RAM 21 again. When the signal VD becomes “1” and a valid pixel is outputted to ADOUT, the RAM 21 is read, the average of the number of pixels of a shielded line is calculated by a divider 24, and the result is subtracted from the value of the valid pixel outputted to ADOUT by a subtracter 22. Then, its upper limit is restricted by a limiter circuit 23 and the pixel whose offset value is compensated for is outputted to POUT.

A preferred embodiment related to the selection of a shielded line used to correct the offset value of the AD conversion circuit is described below.

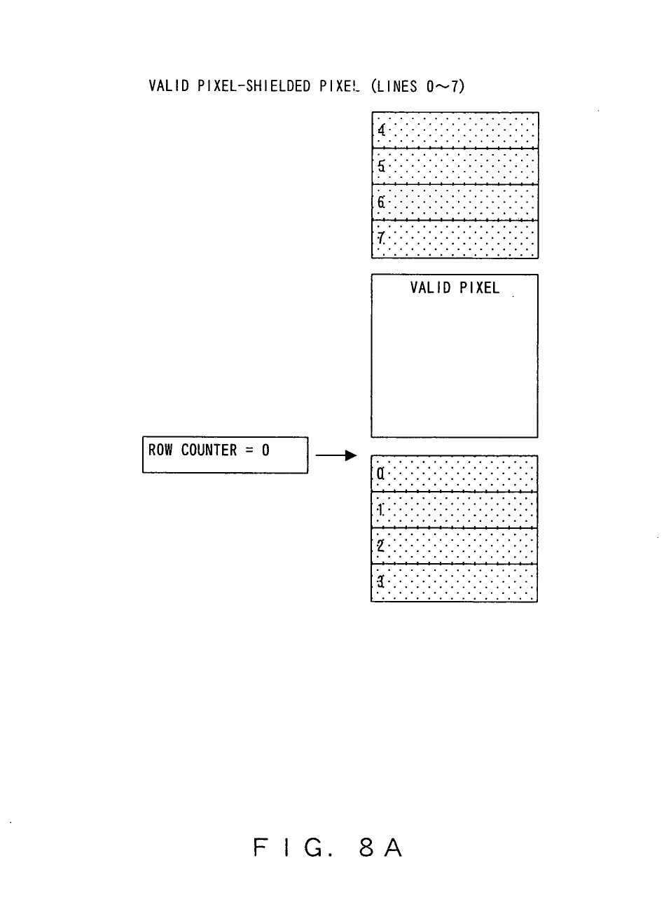

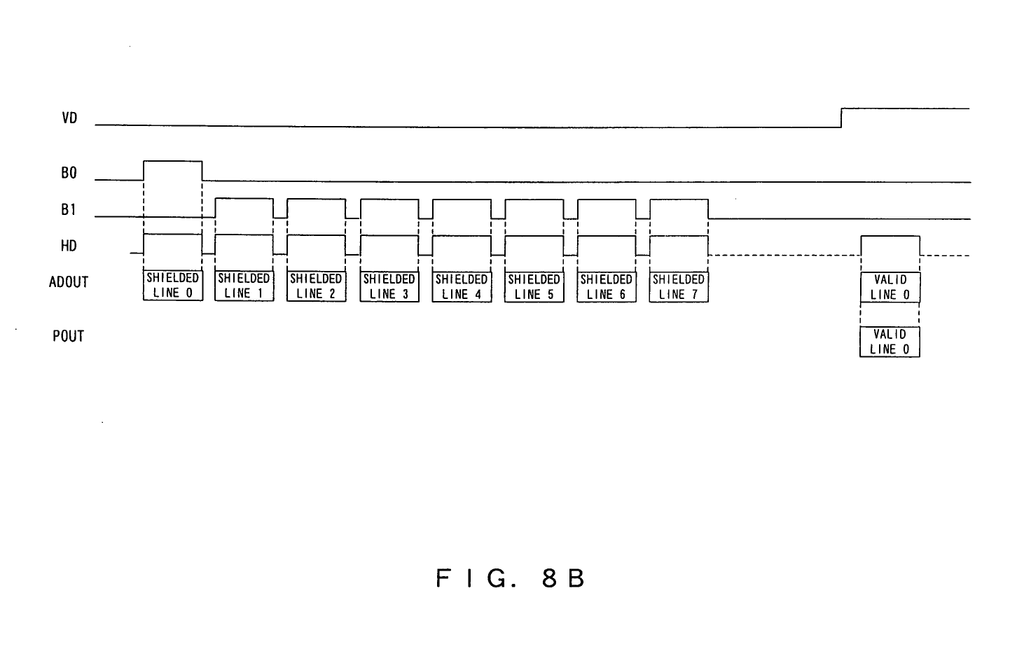

FIGS. 8A and 8B explain the first preferred embodiment in which the offset value is corrected using all shielded lines above and below valid pixels. Four shielded lines are provided above and below the array of valid pixels.

Since an offset correction value must be calculated before a valid pixel is read, a line to be read first is the leading line of a shielded line provided below the valid pixels as shown in FIG. 8A. After the pixels of the shielded lines below the valid pixels have been read, the leading line above the valid pixels is read first and then the remaining lines are read downward.

As shown in FIG. 8B, in the timing the pixel data of shielded line 0 appears in the output ADOUT of the AD conversion circuit, B0 becomes “1”, and as described earlier with reference to FIG. 7, the pixel data of shielded line 0 is written into the RAM 21. At the timing the pixel data of shielded lines 1 through 7 is outputted to ADOUT, B1 becomes 1, and the full pixel data of shielded lines 0 through 7 are used to correct the offset value of the AD conversion circuit.

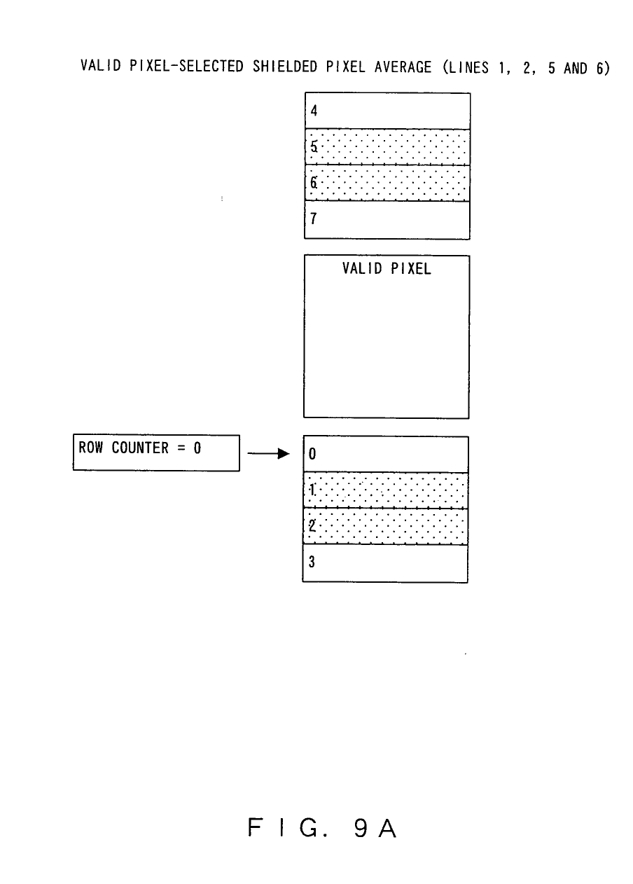

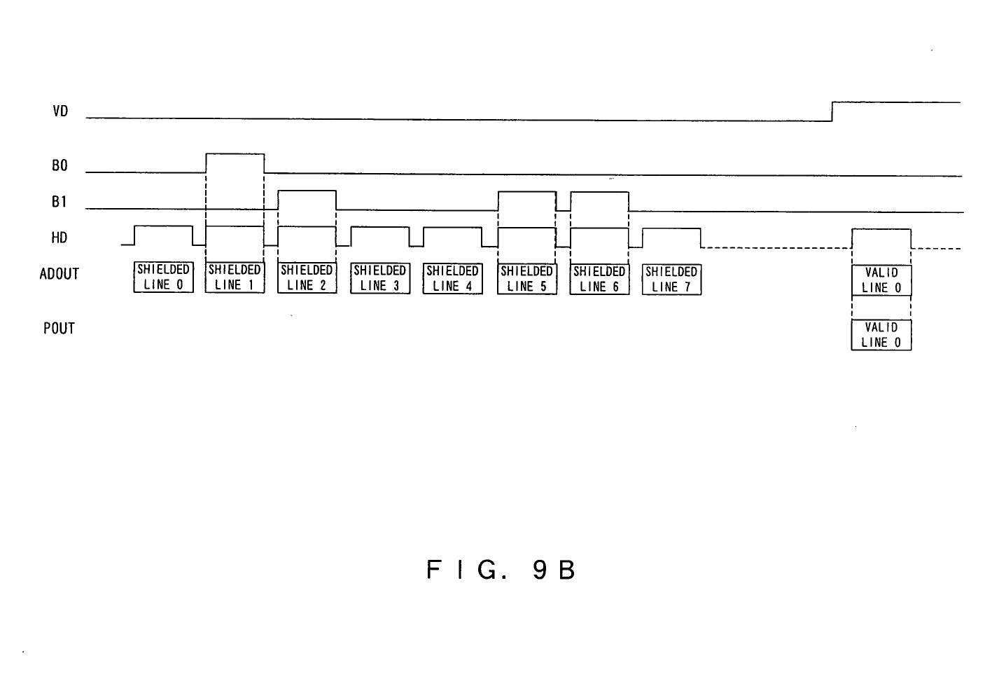

FIGS. 9A and 9B explain the second preferred embodiment in which an offset value is corrected by selecting two lines from each of the shielded lines above and below valid pixels. As shown in FIG. 9A, the reading order of the shielded lines is the same as that as shown in FIG. 8A. In FIG. 9A, for example, as the two upper and two lower shielded lines are to be used to correct the offset value, shielded lines at the row counter values of 1, 2, 5 and 6 are selected.

As shown in FIG. 9B, in the timing the pixel data of shielded line 1 appears in ADOUT, B0 becomes “1”. Then, the respective pixel data of shielded lines 2, 5 and 6 are selected and are used to correct the offset value.

As clearly exemplified in FIG. 9B, which shielded line pixel data to select and use in order to correct the offset value can be controlled by the timing of the rising edges of signals B0 and B1.

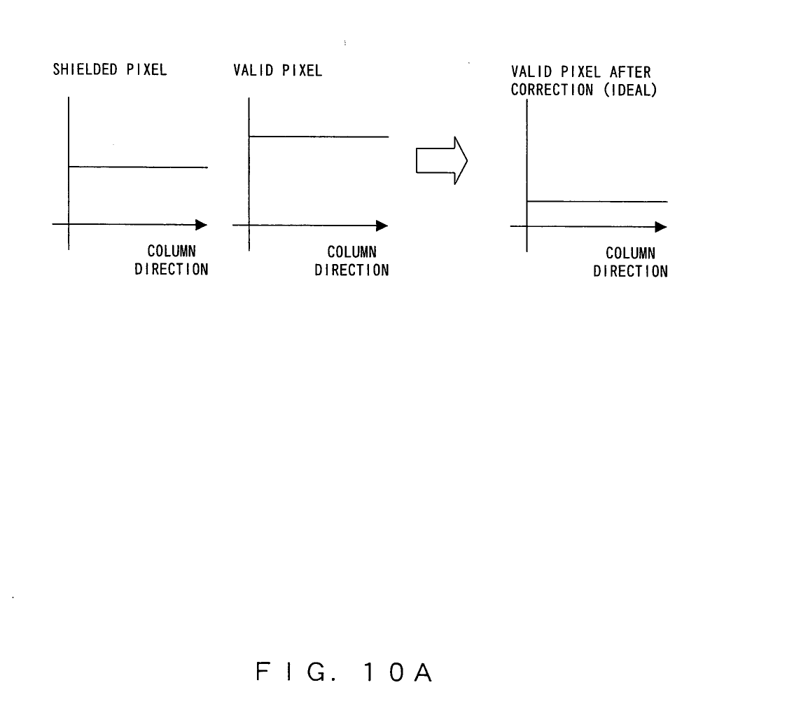

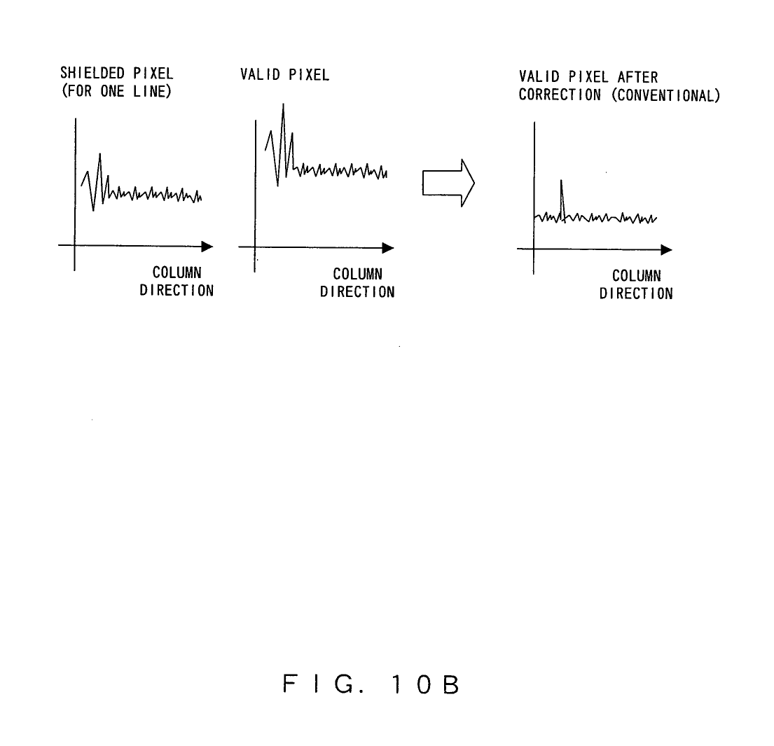

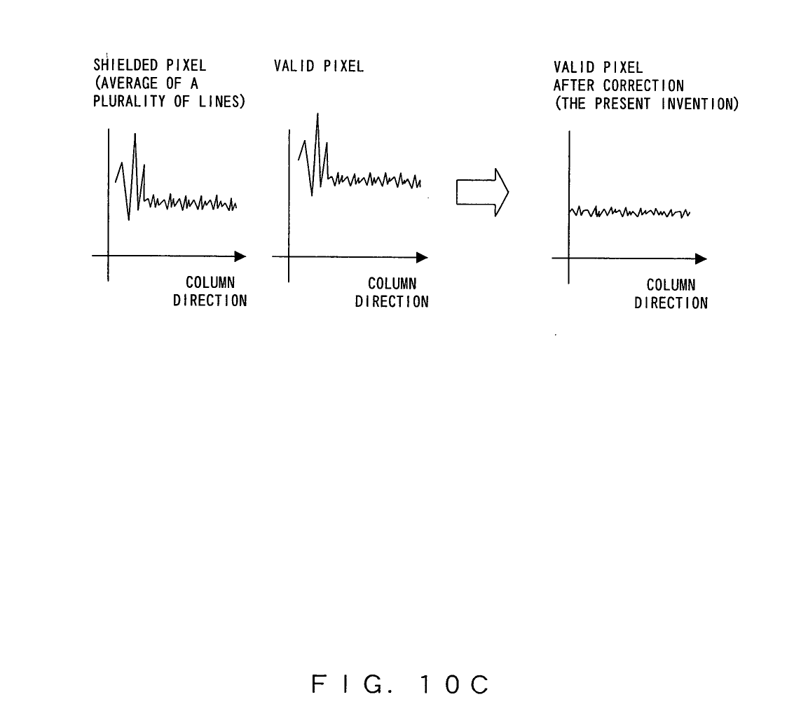

FIGS. 10A, 10B and 10C show the ideal result, conventional result and result according to the present invention, respectively, of the offset value correction of an AD conversion circuit.

In the conventional method for correcting an offset value using only one specific line, as shown in FIG. 10B, sometimes the compensation of the variation of the offset of an AD conversion circuit in a specific column is insufficient, and there is a possibility that vertically-striped noise may occur.

However, in the present invention, since an offset value is corrected using a plurality of shielded lines, as shown in FIG. 10C, the offset value can be corrected almost ideally as shown in FIG. 10A.

In this case, a shielded line to be used to correct an offset value can be selected based on the timing of the rising edges of control signals B0 and B1 and the respective timings of control signals B0 and B1 can be modified by changing the setting value of the setting table 191 shown in FIG. 6. Therefore, even when a shielded pixel line contains a defective pixel, erroneous correction can be avoided by excluding it from line candidates to be corrected. Furthermore, a lot of lines can be averaged by using the averages of upper and lower pixels. The variation of the location of a pixel can also be taken into consideration.

Furthermore, although in the above examples, a plurality of lines is average, a variety of arrangements is possible. For example, it can also be arranged in such a way that the closer to an unshielded pixel a line is, the heavier the weight that is attached to it.

What is claimed is:

1. An image sensor, comprising:
a pixel array of a valid pixel;
a shielded pixel composed of a plurality of lines disposed on each side of a column direction of the valid pixel array; and an AD conversion circuit in each column, wherein
an offset value of the AD conversion circuit is corrected using a value based on an output of a plurality of lines composed of the shielded pixels in each column.

2. An image sensor, comprising:
a pixel array of a valid pixel;
a shielded pixel composed of a plurality of lines disposed on each side of a column direction of the valid pixel array;
an AD conversion circuit in each column; and
a noise reduction circuit for correcting an offset value of each AD conversion circuit, using a value based on an AD conversion circuit output of a plurality of lines composed of the shielded pixels in each column.

3. The image sensor according to claim 2, further comprising:
a row selector for selecting a position in a row direction of said pixel;
a column selector for selecting a position in a column direction of said pixel;
a timing generator for enabling the row and column selectors to sequentially and periodically select the row and column direction positions, respectively, of said pixel and generating synchronous signals in the row and column directions in synchronization with a timing at which pixel values in the selected row and column direction positions are digitized by said AD conversion circuit and are outputted, wherein
said noise reduction circuit further comprises
a storage unit for selecting part of or an entire AD conversion circuit output in each column direction of said shielded pixel outputted in synchronization with the synchronous signal and storing the value based on the selected AD conversion circuit output;
a subtraction unit for subtracting an average value stored in the storage unit from the AD conversion output of each line of the valid pixel in each column; and
an output unit for outputting the subtraction result of the subtraction unit.

4. The image sensor according to claim 3, wherein
when the subtraction result is negative or exceeds a predetermined upper limit, said output unit corrects the result to each predetermined value and outputs the predetermined value.

5. The image sensor according to claim 3, wherein
said timing generator supplies said noise reduction circuit with a control signal for selecting part of or an entire AD conversion circuit output in each column direction of said shielded pixel, and
said noise reduction circuit selects the part of or the entire AD conversion circuit output in each column direction of said shielded pixel, based on the control signal.

6. The image sensor according to claim 5, wherein
said timing generator comprises a table in which a shielded pixel line corresponding to the AD conversion circuit output in each column direction of the shielded pixel selected by said noise reduction circuit can be specified and set from the outside and supplies said noise reduction circuit with the control signal, based on a setting value of the table.

7. The image sensor according to claim 3, wherein
said row selector sequentially selects all positions in the row direction of the shielded pixel composed of a plurality of lines disposed on each side of the column direction of said valid pixel array, and then the position in the row direction of said valid pixel.
